(19) United States
(12) Patent Application Publication
(10) Pub. No.: US 2002/0104339 A1
(43) Pub. Date: Aug. 8, 2002

(54) Lock

(76) Inventor: Roger Saner, Pleigne (CH)

Correspondence Address: JACOBSON HOLMAN PLLC, 400 SEVENTH STREET N.W., SUITE 600, WASHINGTON, DC, 20004, US

(21) Appl. No.: 10/050,605

(22) Filed: Jan. 18, 2002

(30) Foreign Application Priority Data
Jan. 19, 2001 (CH) 2001 0079/01

(51) Int. Cl. E05B 59/00; E05B 63/14

(52) U.S. Cl. 70/108

(57) ABSTRACT

A substantial disadvantage of known three-point bolt locks is their limited usability. Thus, all known locks are either so-called “handle-operated” locks or “key-operated” locks, i.e. locks in which the latch bolt and/or at least the additional bolts are retracted and extended by means of a handle or a key. An alternative use of known locks for “key operation” or “handle operation” is not possible. The invention relates to a novel multipoint lock bolt which, when installed in a door or in a gate, can be set by relatively simple positioning or adjustment of a functional element either for handle operation or key operation. A further development of the invention envisages providing the lock according to the invention with a two-part follower whose halves are superposed in the axial direction. Furthermore, the invention is distinguished by a novel lock advance mechanism, a novel tumbler and a likewise novel panic function which, in the event of danger, permits easy and fast opening of a locked safety door from the inside.

### BACKGROUND OF THE INVENTION

The invention relates to a lock, in particular a three-point connecting-rod lock.

A three-point connecting-rod lock, also referred to as three-point lock, is disclosed, for example, in German Patent Application 28 45 957. The lock disclosed there has a follower consisting of two halves, a spindle being coordinated with each follower half. The latch bolt can be drawn back with the inside spindle, by operating the handle. For this purpose, the follower half coordinated with the inside handle has an arm which cooperates with an actuating projection of the latch bolt. In the case of this known lock, the latch bolt can be drawn back only by actuating the inner follower half. Actuation of the outer follower half does not result in the latch bolt being drawn back.

A second three-point lock is disclosed in European Patent Application 0 712 987. In the case of this lock, too, the follower is divided into two parts. The two follower parts are located axially one behind the other in the axial direction of the handle and each receives a spindle section of a spindle divided in the middle. Each of the two follower halves has an arm which can cooperate if desired with a stop of the bolt tail in order to draw back the latch bolt. Such an arrangement makes it possible to provide two handles on an entrance door, but in this case too the latch bolt can be drawn back only by means of the inside handle.

The disadvantage of the locks mentioned at the outset is the limited usability. Thus, the above-mentioned locks are so-called “handle-operated” locks, i.e. locks in which the latch bolt and/or at least the additional bolts are extended and drawn back by means of a handle. An alternative use of these locks for “key operation”, i.e. extending and drawing back the latch bolt and/or all bolts by means of a key, is not possible. In addition, owing to the design, the lock disclosed in EP A 0 712 987 can be used either only for doors fitted with a lock on the left or doors fitted with a lock on the right.

### SUMMARY OF THE INVENTION

It is the object of the invention to further develop a lock of the generic type in a manner advantageous for use so that the lock can be used if desired for true, classical “key operation” or for true, classical “handle operation”.

This object is achieved by a lock having a latch bolt which can be drawn back by means of a handle or by means of a key, a follower, a main bolt, a vertically displaceable connecting-rod slide which is connected to at least one additional bolt by means of at least one connecting rod, a pivoted lever for displacing the connecting-rod slide and a tumbler for securing the main bolt in the locked state, characterized by a functional element which makes it possible to adjust the lock, on installation in a door or in a gate, in such a way that the retraction and extension of the at least one additional bolt are possible by means of either the key or the handle, it being possible for the latch bolt to be drawn back by means of the key in the case of key operation.

The achievement stated in patent claim 1 aims at designing the lock with a functional element in such a way that, on installation in a door or in a gate, it can be adjusted alternatively for handle operation or for key operation by a relatively simple positioning or adjustment of said functional element.

A further development of the invention envisages providing the lock according to the invention with a two-part follower whose halves coincide with one another in the axial direction. Particularly in the case of fittings having two handles, the two spindles as well as the two follower halves are rotationally decoupled so that actuation of the inside handle or of the outside handle has no influence on the other, opposite handle or the follower half coordinated with this handle.

Three-point locks usually have a main bolt which can be locked and drawn back by means of a key. A tumbler which secures the extended bolt and prevents it from performing an undesired movement is coordinated with the main bolt. Three-point locks can furthermore be equipped with a so-called panic function which, in the case of danger, permits easy and fast opening of a locked safety door from the inside.

With reference to these designs of three-point locks, the invention furthermore relates to a novel lock having a lock cylinder, for extending and retracting at least the main bolt by means of a key, and a driver plate arranged on the bolt tail and capable of being acted upon by a locking member of the lock cylinder, characterized in that the driver plate is arranged in such a way that, on locking and on acted upon by the locking member, it moves downward along a curve toward the lock cylinder and thereby ejects the main bolt linearly.

The invention further relates to a lock, characterized by a fork-like tumbler which rests with its fork base against the side wall of the lock case and forms at least one stop for the bolt tail end with its prongs, and to a lock, being present in the “key-operated” embodiment, characterized by

fittings comprising an inside handle and an outside knob or an inside handle and an outside handle,

a plate-like panic element which, in the event of danger, permits easy and fast opening of the lock and connects the tumbler in a rotationally effective manner to the follower and the inside handle,

panic element and tumbler being pivotably coupled to one another in such a way that, when the handle is pressed down, the tumbler is raised and thus the locking action of the tumbler with respect to the bolt tail is eliminated so that, simultaneously and likewise as a result of pressing down the handle, the latch bolt, the main bolt and the additional bolts are drawn back.

Advantageous embodiments of the invention form the subject of the dependent claims.

### BRIEF DESCRIPTION OF THE DRAWINGS

The invention is explained in more detail below with reference to the drawings. In the drawings,

FIG. 1 shows a three-point connecting-rod lock with opened cover in the starting position, i.e. with bolts drawn back,

FIG. 2 shows the lock according to FIG. 1 with additional bolts extended,

FIG. 3 shows the lock according to FIG. 1 with main and additional bolts extended,

FIG. 4 shows the lock according to FIG. 1 with main bolt drawn back,

FIG. 5 shows the lock according to FIG. 1 with main and additional bolts drawn back and latch bolt drawn back,

FIG. 6 shows the lock according to FIG. 1 in the starting position and formed for key operation with at least one button instead of a handle,

FIG. 7 shows the lock according to FIG. 6 with main bolt extended and additional bolts extended,

FIG. 8 shows the lock according to FIG. 6 with an inside handle and a panic function part in the locked position and

FIG. 9 shows the lock according to FIG. 8 in the unlocked open position.

### DESCRIPTION OF THE PREFERRED EMBODIMENTS

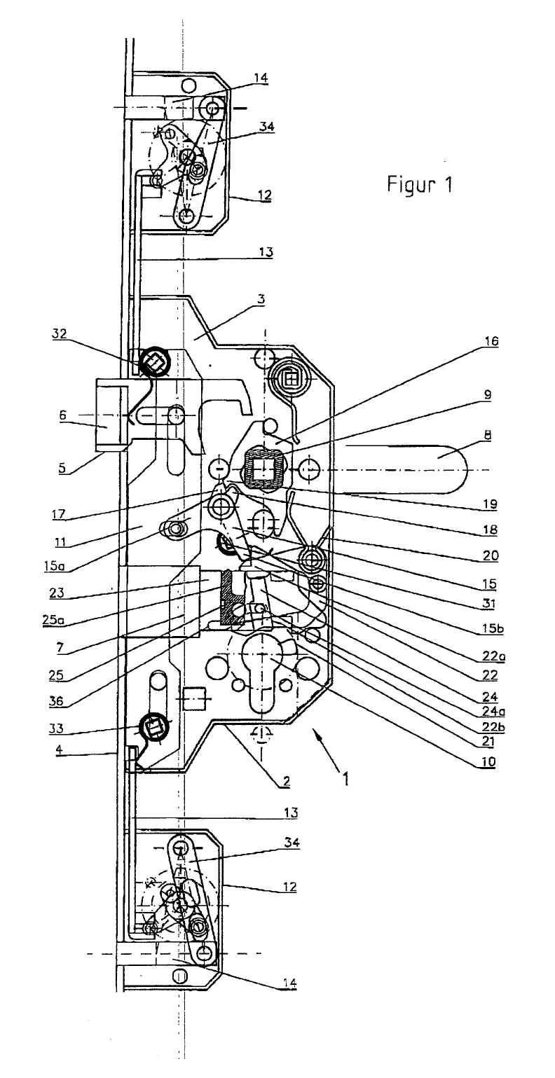

The lock shown in FIGS. 1 to 9 and denoted as a whole by 1 has a lock case 2 with a lock base 3 and a lock cover which is not shown. On the front, the lock 1 has a sleeve 4 which possesses openings through which a latch bolt head 5 of a latch bolt 6 and a bolt 7 pass.

The latch bolt 6 can be drawn back by means of a handle 8, which in turn fits in a follower 9. Furthermore, the lock 1 has a lock cylinder 10 so that the bolt 7 can be extended and drawn back by means of a key.

Along the sleeve 4, a connecting-rod slide 11 is arranged vertically displaceably in the lock case 2. Said slide serves for vertically moving the connecting rods 13 connected to the two additional locks 12, for drawing back and extending the additional bolts 14, and for doing so as in the case of the known three-point locks of MSL Schloss- und Beschlägefabrik AG, CH Kleinlützel, Switzerland.

A pivoted lever 15 which engages the follower 9, or the handle 8 fitted in the follower 9, by means of a first driver 16 substantially serves for displacing the connecting-rod slide 11.

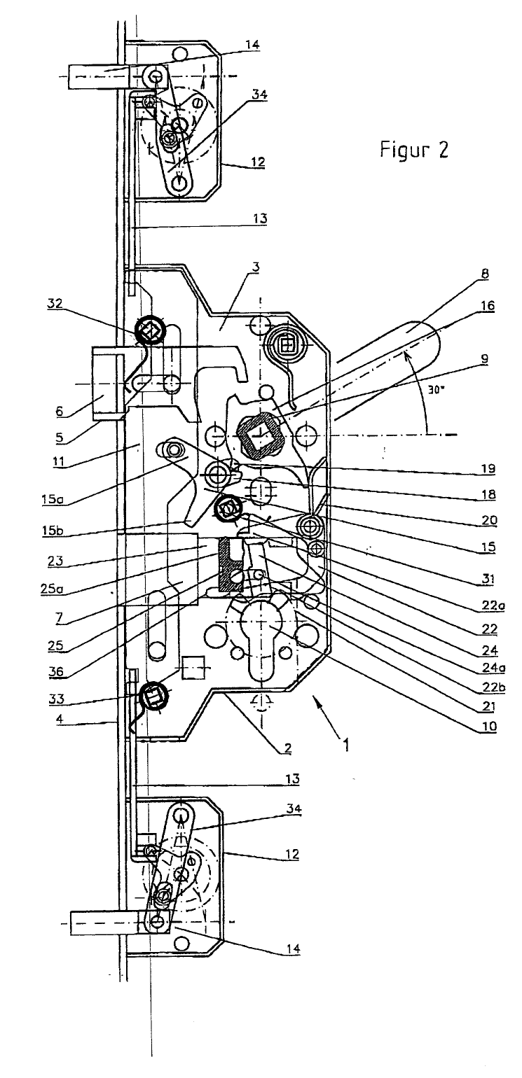

By swiveling the handle 8 30° upward from the starting position, the connecting-rod slide 11 is displaced upward along the sleeve 4, whereupon the two additional bolts 14 of the additional lock 12 are extended. FIG. 1 shows the connecting rod position corresponding to the opening or starting position and FIG. 2 shows the connecting rod position corresponding to the locking position.

The substantially angular pivoted lever 15 is fastened with its apex rotatable on the lock bottom 3 and with its end 15a shown on the left in FIG. 1 rotatable on the connecting-rod slide 11. In the apex region, it has two teeth 17 and 18 opposite one another and offset from one another in the direction of the axis of rotation. Of said teeth, the tooth 18 forms a stop for the peg 19 of the driver 16 which, when the handle 8 is lifted, moves the connecting-rod slide 11 upward and thus triggers the locking of the additional locks 12. If the handle 8 is therefore moved upward (FIG. 2) starting from the starting position shown in FIG. 1, the pivoted lever 15 is carried along by contact with the tooth 18. In association with this swiveling of the pivoted lever 15, the connecting-rod slide 11 is displaced upward. The lock 1 is then in the locking position shown in FIG. 2. If the handle 8 is released in this position, spring-loaded restoration of the handle 8 by the return spring 20 is effected.

The bolt 7 provided in the lock case 2 can be locked and drawn back by actuation of the lock cylinder 10. For this purpose, the lock cylinder 10 has a locking member 21 which cooperates with the bolt 7 and a tumbler 22. Furthermore, a driver plate 24 which can be acted upon by the locking member 21 is displaceably mounted on the bolt tail 23.

According to the invention, a locking slide 25 is additionally arranged on the bolt tail 23. The slide 25 rests in a recess of the bolt tail 23 and has an upward-projecting lug 25a which—as will be explained in more detail below can if desired be positioned so that it cooperates with the pivoted lever end 15b.

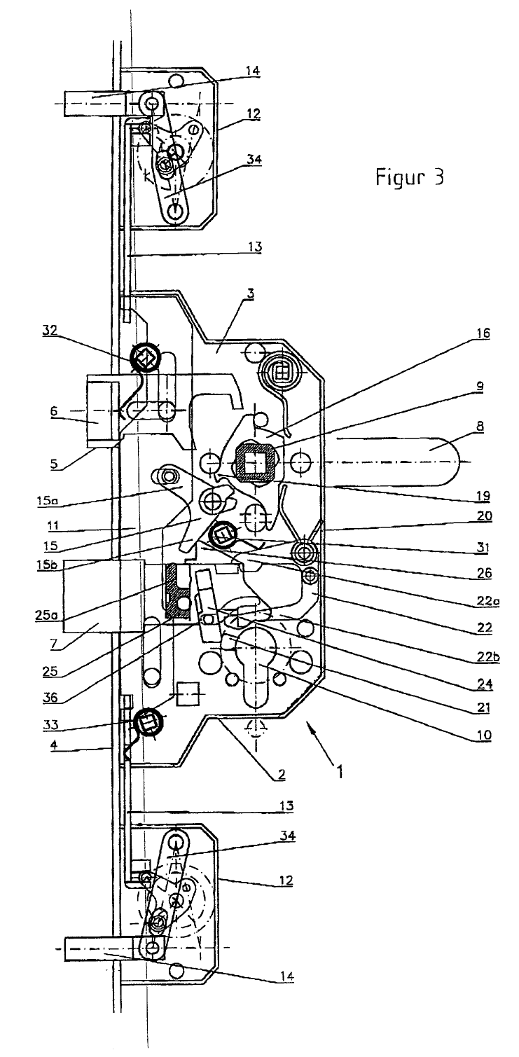

The mode of operation of the lock 1 in the “handle-operated” embodiment, as shown in FIGS. 1 to 5, is as follows: In the handle position shown in FIG. 3, the bolt 7 is advanced by means of a key, i.e. the lock is locked. The locking member 21 engages the driver plate 24 and ejects the bolt 7. In the locked state shown in FIG. 3, the bolt 7 is held by the tumbler 22, by stops which are provided on said tumbler and on the bolt tail end and match one another.

In the locking position, the pivoted lever 15 is furthermore held nonpivotably by that lug 26 of the bolt tail 23 which comes into contact with said lever, so that the handle 8 can no longer be pressed down in order to displace the connecting rods 13 to the starting position.

As is evident in particular from FIGS. 2 and 3, the driver plate 24 does not move linearly in the bolt ejection direction during locking but moves downward along a curve toward the lock cylinder 10. This movement is guided by an arc-shaped slot 36 which is provided in the lock cover (not shown) and into which a pin 24a of the driver plate 24 projects. As a result of this guidance of the driver plate 24, the bolt 7 can be ejected over a relatively long distance without additional translation means through which transmission forces may be lost, since the locking member 21 engages the driver plate 24 over a large part of its rotation.

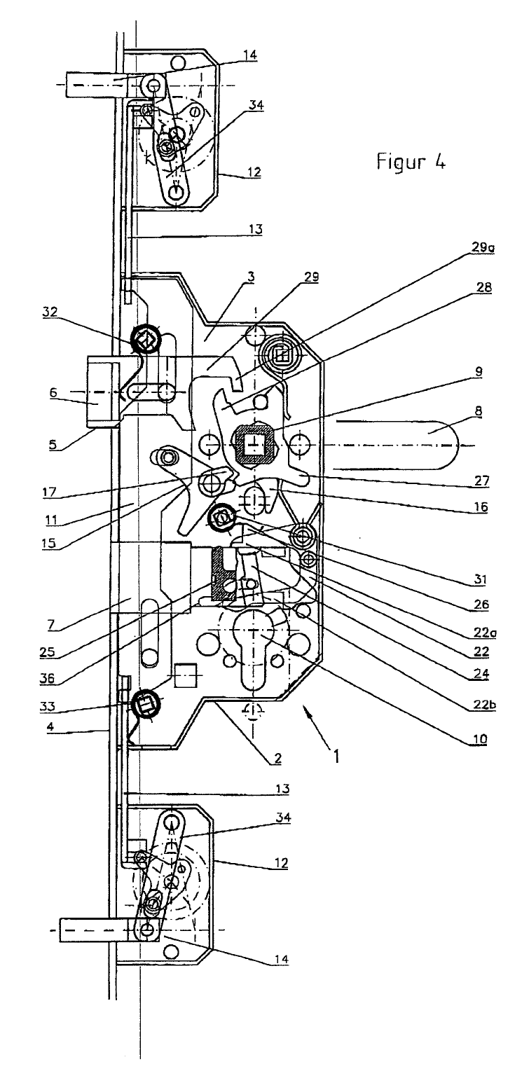

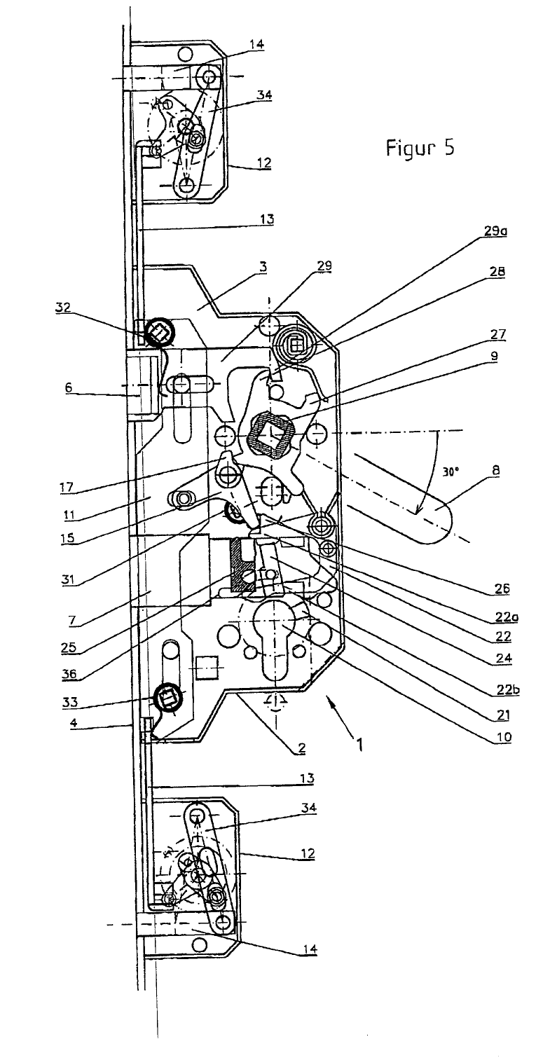

If the bolt 7 is drawn back by means of the key, the lug 26, too, is displaced backward so that—as shown in FIGS. 4 and 5—the pivoted lever 15 and hence also the follower 9 can be swiveled again by actuation of the handle 8. Associated with the swiveling of the follower 9 as a result of the handle 8 being pressed down, the tooth 17 of the pivoted lever 15 is acted upon in the opposite direction by a second driver 27 resting on the first driver 16, so that the pivoted lever 15 is displaced back into the starting position shown in FIG. 1, i.e. the additional locks 12 are opened again. When the handle 8 is pressed down through 30°, the latch bolt 6 is also drawn back. As is evident from FIG. 5, this is effected by the lug 28 of the second driver 27, which lug engages the projection 29a of the bolt tail 29 when the handle 8 is pressed down.

For the sake of simplicity, only one handle 8 is shown in FIGS. 1 to 5. In the embodiment shown in FIGS. 1 to 5, however, the outside fittings of the lock 1 are preferably provided with two handles, i.e. with an outside handle and an inside handle.

In FIGS. 1 to 5, the lock 1 is designed in such a way that the retraction and extension of the additional bolts 14 are effected by means of the handle 8 and the retraction and extension of the main bolt 7 are effected by means of a key. According to the invention, the lock 1 can, however, also be designed in such a way that the retraction and extension of all bolts are effected in only one step by means of said key. For this purpose, a simple conversion of the locking slide 25 is required.

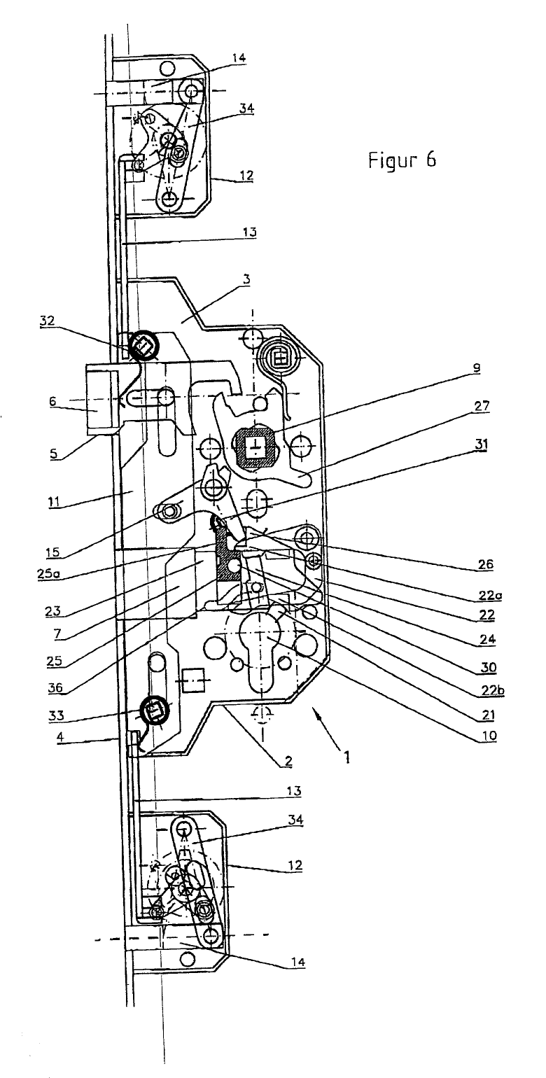

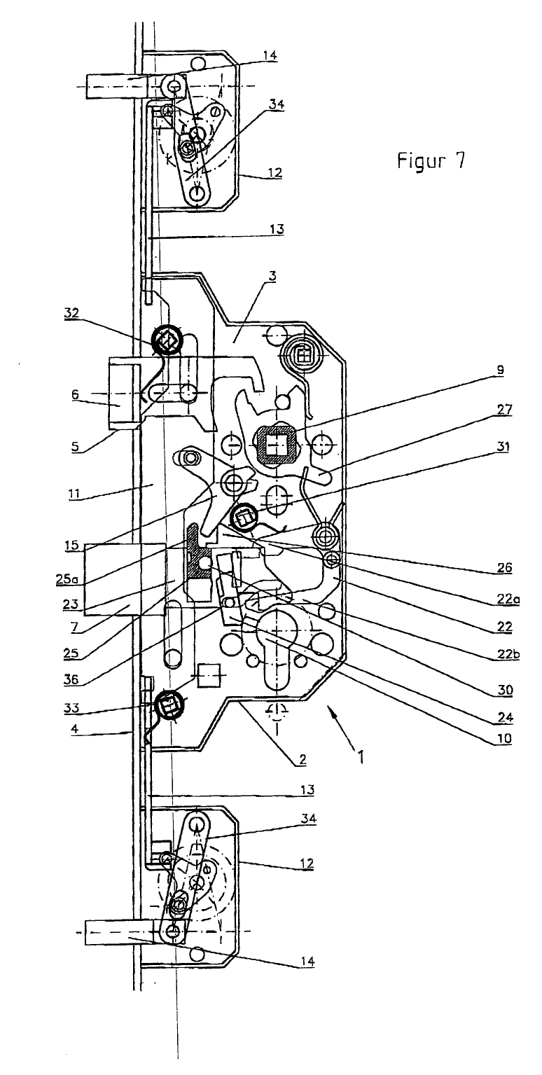

FIGS. 6 and 7 show the lock 1 in the “key-operated” embodiment. In the lock 1 in this form, the slide 25 with its lug 25 projects beyond the bolt tail 23 and engages the free end 15b of the pivoted lever 15.

If the lock 1 is to be converted from the “handle-operated” embodiment shown in FIGS. 1 to 5 into the “key-operated” form, all that is therefore necessary is to move the slide 25 upward and to fix it in the extended position, for example by means of a positioning spring 30. In the present case, the desired position can be set directly from the outside in a simple manner and without opening the lock case 2.

FIG. 6 shows the lock 1 in the starting position, i.e. in the unlocked state. In this case, the mode of operation of the lock 1 is as follows: The bolt 7 is advanced by means of a key. The locking member 21 engages the driver plate 24 and ejects the bolt 7. At the same time, the pivoted lever 15 is swiveled by the lug 26 of the bolt tail 23 so that the connecting rods 13 are moved upward and the additional bolts 14 are extended. The lock 1 is then in the locking position shown in FIG. 7. In this locked state too, the bolt 7 is held nondisplaceably by the tumbler 22, by means of stops which are provided on said tumbler and on the bolt tail end and which match one another.

If the bolt 7 is retracted by means of the key, the locking slide 25 carries the free end 15b of the pivoted lever 15 along and returns it to the starting position so that main and additional bolts 7 and 14 are thus simultaneously drawn back. Particularly in the case of stable locking doors which are not susceptible to distortion and have an inside handle and an outside knob, the lock 1 has, in the “key-operated” embodiment, a so-called alternate function which is substantially characterized in that the opening of the door from the outside is effected by turning the key inserted in the lock cylinder, the bolt first being drawn back with a first turn and then the latch bolt being drawn back with a ¼ turn.

In the embodiment shown in FIGS. 6 and 7, the outside fittings of the lock 1 are alternatively provided with two knobs or an outside knob and an inside handle. However, the lock 1 can also be functionally designed in such a way that the bolts 7 and 14 are only partly extended on locking with the key and are brought into their final locked position only by means of the handle. In this case, for unlocking and opening the lock 1, the bolts 7 and 14 are accordingly only partly drawn back by means of the key and completely drawn back by means of the handle, the latch bolt 6 then also simultaneously being drawn back. This functional mechanism is important in particular for doors susceptible to distortion, so that in the case of said doors the bolt ejection and the bolt retraction can be supported by means of a handle if the key force is insufficient for this purpose.

If the fittings of the lock 1 consist of an inside handle and an outside knob or at any rate of two handles, the follower 9 is preferably formed in two parts. The two follower halves are congruent and preferably have mirror symmetry, so that either the one or the other follower half can be coupled to the latch bolt 6. The follower halves are moreover rotationally decoupled so that actuation of the inside handle or of the outside handle does not influence the opposite knob or the other handle. The coupling members of the follower 9 which are not indicated in the drawing are preferably detachable and therefore also displaceable or relocatable after manufacture of the lock 1, so that the coupling between latch bolt 6 and follower 9 is adjustable.

The tumbler 22 used in the lock 1 has the form of a fork. It rests with its fork base against the side wall of the lock case 2 and, with its prongs 22a and 22b, forms at least one stop for the bolt tail end, which stop, in the locked state shown in FIGS. 3 and 7, blocks the bolt 7 and prevents it from forming an undesired movement. Relatively high stability and a blocking action of the tumbler 22 are ensured, according to the invention, by the form of the prong 22a leading outward or upward away from the bolt tail 23 and by the direct proximity of the tumbler 22 to the side wall of the lock case 2.

Apart from the above-mentioned components of the lock 1 and the functions explained in detail, the lock 1 is formed in an identical manner to the known three-point locks of MSL Schloss- und Beschlägefabrik AG, Kleinlützel, Switzerland. A detailed description of the function of the tumbler spring 31, of the latch bolt spring 32, of the positioning spring 33 and of the rockers 34 will therefore be dispensed with below.

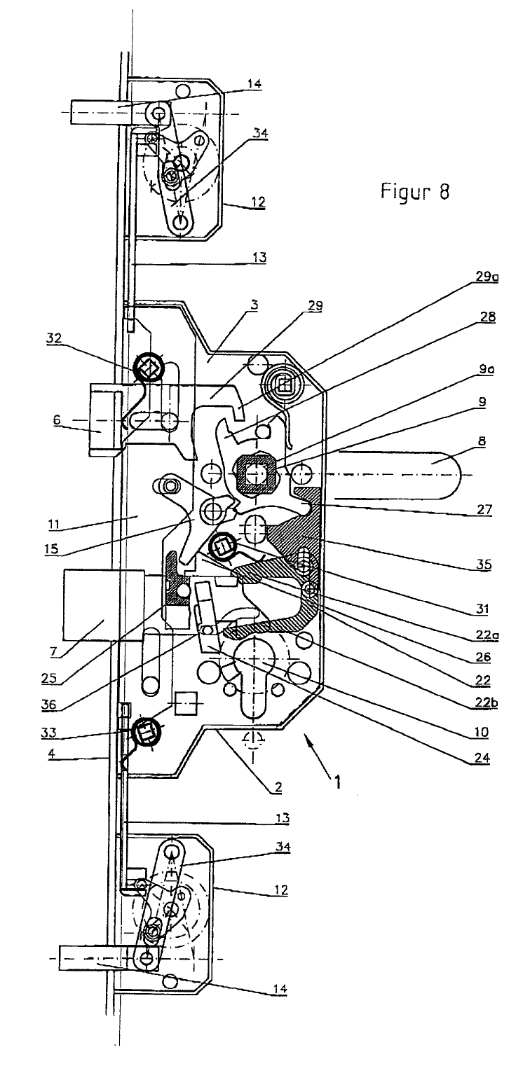

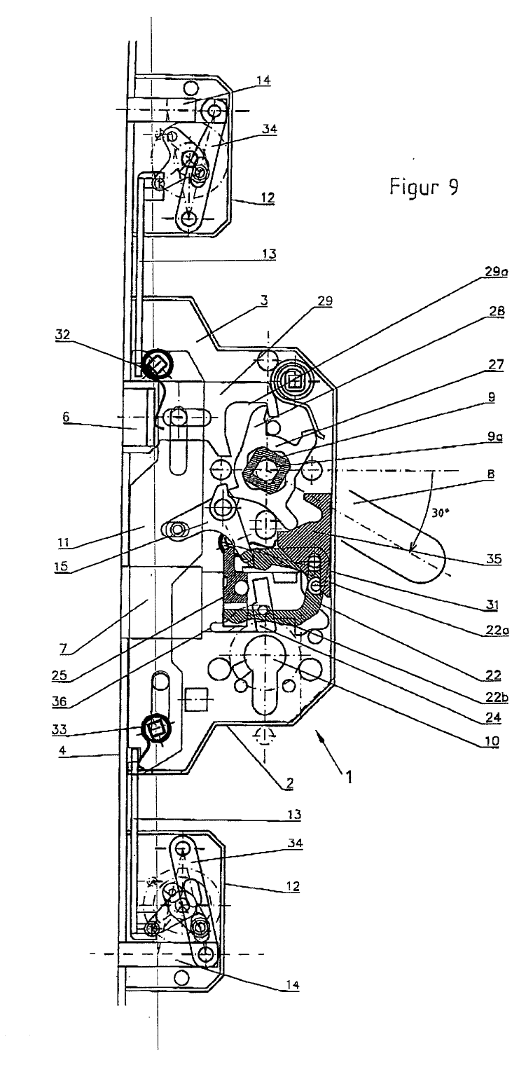

The invention furthermore relates to a mechanism for implementing the panic function stated at the outset, which, in the event of danger, permits easy and fast opening of a locked safety door from the inside. This mechanism can preferably be integrated in a lock of the type described above, the latter having, as fittings, either an inside handle and an outside knob or an inside handle and an outside handle. FIGS. 8 and 9 show the lock 1 having such a mechanism.

A precondition for the integration of the panic function in the lock 1 is that said lock is in the “key-operated” embodiment. The locking of such a panic lock is thus effected as already described above with reference to FIGS. 6 and 7, by means of a key which simultaneously ejects the main and additional bolts 7 and 14.

The mechanism of the panic function is based substantially on a plate-like panic element 35 which—as shown in FIGS. 8 and 9—couples the tumbler 22 with the second driver 27, which in turn is connected in a rotationally effective manner via the follower 9 to the inside handle 8. Panic element 35 and tumbler 22 are pivotably coupled to one another in such a way that, when the inside handle 8 is pressed down by 30°, the prongs 22a and 22b of the tumbler 22 are raised at their free ends. Consequently, the blocking action of the tumbler 22 with respect to the bolt tail 23 is eliminated so that, simultaneously and likewise as a result of pressing down the inside handle 8, the latch bolt 6, the main bolt 7 and the additional bolt 14 are drawn back. The turning back of the pivoted lever 15 to the starting position, which is required for drawing back the additional bolt 14, is however effected in this case only when the lock 1 is of the “key-operated” form, i.e. has the slide 25 in the pushed-out or raised position.

The panic function according to the invention is substantially characterized in that, regardless of the choice of the outside fittings, it is designed in such a way that, in the locked state, any outside handle and latch bolt present are blocked. Depending on the choice of the fittings, the locks according to the invention which are provided with the panic function described above differ, especially in the opening of the lock from outside. Thus, in the case of fittings comprising an outside knob, opening is effected by turning the key inserted in the lock cylinder, with the result that—as already mentioned—the bolts are first drawn back with a first turn and then the latch bolt is drawn back with a second turn. In the case of fittings comprising an outside handle, opening is effected by a single turn of the key, with the result that the bolts are drawn back, and by subsequent pressing of the outside handle for drawing back the latch bolt.

Particularly if one handle each is mounted for the inside and outside fittings, the two-part follower 9 is provided with a separating disk 9a for implementing the panic function. The purpose of this is to ensure that the actuation of one handle has no influence on the opposite other handle or the follower half coordinated with this handle.

According to the invention, the lock 1 can be formed with a tumbler according to claim 8 and/or a mechanism for implementing the panic function according to claim 9. It should finally be noted at this point that the tumbler and panic function described above can also be used independently of one another in other locks.

What is claimed is:

1. Lock, in particular connecting-rod lock, having a latch bolt which can be drawn back by means of a handle or by means of a key, a follower, a main bolt, a vertically displaceable connecting-rod slide which is connected to at least one additional bolt by means of at least one connecting rod, a pivoted lever for displacing the connecting-rod slide and a tumbler for securing the main bolt in the locked state, characterized by a functional element which makes it possible to adjust the lock, on installation in a door or in a gate, in such a way that the retraction and extension of the at least one additional bolt are possible by means of either the key or the handle, it being possible for the latch bolt to be drawn back by means of the key in the case of key operation.

2. Lock according to claim 1, wherein the substantially angular pivoted lever engaging the follower can be fastened with its apex rotatable on the lock bottom and with its one end rotatable on the connecting-rod slide, wherein the bolt tail of the main bolt which faces the tumbler can be made to engage the second, free end of the pivoted lever, and wherein a locking slide which can alternatively be positioned so that, in the “key-operated” embodiment of the lock, it cooperates with the pivoted lever end is arranged as a functional element on the bolt tail.

3. Lock, in particular according to claim 1, having a lock cylinder, for extending and retracting at least the main bolt by means of a key, and a driver plate arranged on the bolt tail and capable of being acted upon by a locking member of the lock cylinder, wherein the driver plate is arranged in such a way that, on locking and on acted upon by the locking member, it moves downward along a curve toward the lock cylinder and thereby ejects the main bolt linearly.

4. Lock according to claim 1, wherein its outside fittings are provided alternatively with two handles (8) or one outside knob and one inside handle (8).

5. Lock, in particular according to claim 1, wherein the follower is in the form of two parts and that the two follower halves are congruent so that alternatively the one or the other follower half can be coupled to the latch bolt (6).

6. Lock according to claim 5, wherein the two follower halves are rotationally decoupled.

7. Lock according to claim 6, wherein a separating disk is arranged between the two follower halves so that actuation of the inside handle or of the outside handle has no influence on the opposite knob or the other handle.

8. Lock, in particular according to claim 1, wherein a fork-like tumbler which rests with its fork base against the side wall of the lock case is arranged and forms at least one stop for the bolt tail end with its prongs.

9. Lock, in particular according to claim 1, said lock being present in the “key-operated” embodiment, characterized by
fittings comprising an inside handle and an outside knob or an inside handle and an outside handle,
a plate-like panic element which, in the event of danger, permits easy and fast opening of the lock and connects the tumbler in a rotationally effective manner to the follower and the inside handle,
panic element and tumbler being pivotably coupled to one another in such a way that, when the handle is pressed down, the tumbler is raised and thus the locking action of the tumbler with respect to the bolt tail is eliminated so that, simultaneously and likewise as a result of pressing down the handle, the latch bolt, the main bolt and the additional bolts are drawn back.

10. Lock according to claim 1, said lock being present in the “key-operated” embodiment, wherein it is functionally designed, in particular for use for doors susceptible to distortion, in such a way that, on locking with a key, main bolt and additional bolt are only partly extended and are brought into their final locked position by means of a handle, and that, for unlocking and opening the lock, the bolts are only partly drawn back by means of the key and are completely drawn back by means of the handle.
